(19) United States
(12) Patent Application Publication
(10) Pub. No.: US 2001/0018669 A1
(43) Pub. Date: Aug. 30, 2001

(54) Method and system for effecting electronic commerce

(75) Inventor: Yasuhisa Fujiwara, Nishikamo-gun (JP)

Correspondence Address: OLIFF & BERRIDGE, PLC, 277 S. WASHINGTON STREET, SUITE 500, ALEXANDRIA, VA, 22314, US

(73) Assignee: Toyota Jidosha Kabushiki Kaisha

(21) Appl. No.: 09/780,443

(22) Filed: Feb. 12, 2001

(30) Foreign Application Priority Data
Feb. 25, 2000 (JP) 2000-049684

(51) Int. Cl. G06F 17/60; G06F 15/173

(52) U.S. Cl. 705/26; 709/223

(57) ABSTRACT

An electronic commerce method and system effects electronic commercial transactions using a computer network, wherein a management center identifies a user in response to an access from a user terminal, to provide user identification information, and receives a product purchase request from the user terminal. The management center then creates product selection information needed for selection of at least one product and product delivery information needed for delivery of the at least one product, on the basis of the user identification information and/or the product purchase request. The management center then transmits the product selection information to a terminal of a first party, such as a shop, that carries products while transmitting the product delivery information to a terminal of a second party, such as a distributor, that delivers products.

### INCORPORATION BY REFERENCE

The disclosure of Japanese Patent Application No. 2000-049684 filed on Feb. 25, 2000 including the specification, drawings and abstract is incorporated herein by reference in its entirety.

### BACKGROUND OF THE INVENTION

1. Field of the Invention

The invention relates in general to a method and a system for effecting electronic commerce or electronic commercial transactions, and more particularly to improvements in the control of private information and the efficiency of product delivery in an electronic commerce method or system using a computer network in which computers are connected to each other by communication lines.

2. Description of Related Art

With development of computer technologies and communication technologies in recent years, it is possible to effect electronic commerce or electronic transactions, online shopping, and the like by using computer networks.

For example, in a computer system connected to the Internet, a server computer transmits a web page to a user terminal through the WORLD-WIDE WEB (WWW), and the user displays this web page at the terminal by use of a browser or the like, and makes a purchase request for a desired product or products. Each web page has a uniquely defined URL (Universal Resource Locator). The user may transmit a URL of a desired web page to the server computer as needed, and in return the server computer transmits the web page corresponding to the received URL to the user terminal. Upon receipt of a purchase request from the user terminal, the server computer executes a predetermined procedure for settlement and then delivers the requested product(s) through a distribution center when appropriate.

In order to buy a desired product through the electronic commerce system as described above, the user needs to transmit his or her own information (i.e., private information), such as a full name, a home address, a delivery address, and a credit card number used for settlement. This makes it necessary to provide a security technology that prevents these types of information from unnecessarily leaking outside.

For example, in an electronic commerce system as disclosed in Japanese Patent Laid-Open Publication No. 10-78988, a user (a credit card holder), a product dealer, a card administrator, and a distributor are considered as parties concerned. To buy a product using this system, the user encrypts a part of data associated with each of the parties concerned (such as a product dealer and a card administrator) other than the user, using a common encryption key that is valid only between the user and each party, and then transmits the resulting data to the party. Each party, such as a product dealer or a card administrator, which received the encrypted order data decrypts a part of the order data associated with the party in question, using the common encryption key shared by the user and the party in question. Since each party concerned has no common encryption key for decrypting part of the data associated only with other parties, the party has no access to the content of that part of the data and hence the user's private information can be kept secret.

In the above-mentioned conventional technology, however, the party concerned, such as the user, is required to perform necessary encryption and decryption on data, which makes operations at the terminal complicated. Moreover, although the user's private information is encrypted with a common encryption key that is only valid between the user and each party, there still exists a possibility that the user's private information may leak outside through breaking of the encryption code or the like as far as the user's private information goes back and forth between the user and each party in the electronic commerce system. Therefore, a more reliable security technology is desired.

Further, in the conventional technology, order data that is to be transmitted to the other parties in the electronic commerce system when the user intends to buy a product or products consists of the required minimum data, such as a product code and a quantity of products requested, which is only useful for the user and can be entered by the user at the terminal upon purchasing. These items of information may not be the most desirable or useful information for the product dealer and the distributor when they perform their operations, and also may not include contents that enable the product dealer and the distributor to accomplish the operations with high efficiency. Thus, it is desirable to have an electronic commerce system that can adequately process a purchase request for product(s) from the user, and can be operated with improved efficiency.

### SUMMARY OF THE INVENTION

It is therefore an object of the invention to provide a system and a method with which a purchase request from the user can be processed to achieve efficient delivery of products, and which permit the user's private information to be controlled with high reliability without inadvertently leaking outside, thus assuring an improved ease with which the system is used.

The above object and/or other objects may be attained according to a first aspect of the invention, which provides an electronic commerce system for effecting electronic commercial transactions using a computer network in which computers are interconnected, for example, via communication lines. The system (a) identifies a user and generates user information in response to an access from a user terminal, (b) receives a product purchase request from the user terminal, (c) creates product selection information for use by a first party that carries products, the product selection information needed for selection of at least one product, the information is created on the basis of at least one of the product purchase request and the user information, and (d) creates product delivery information for use by a second party that delivers products, the product delivery information needed for delivery of the at least one product, the information is created on the basis of at least one of the product purchase request and the user information.

According to another aspect of the invention, there is provided an electronic commerce method for effecting electronic commercial transactions using a computer network in which computers are interconnected, e.g., via communication lines. The method includes the steps of: (a) identifying a user in response to an access from a user terminal, to provide user identification information, (b) receiving a product purchase request from the user terminal, (c) creating product selection information needed for selection of at least one product and product delivery information needed for delivery of the at least one product, on the basis of at least one of the user identification information and the product purchase request, (d) supplying the product selection information to a terminal of a first party that carries products, and (e) supplying the product delivery information to a terminal of a second party that delivers products.

In the system or method according to these aspects of the invention, the user information is generated from private information of a new and unregistered user or from existing private information of a registered user, and the product selection information and the product delivery information are created by processing the product purchase request received or the user information. Here, the product purchase request and the user information are controlled by a single party that manages the system, and the product selection information is supplied as needed to a party that carries products while the product delivery information is supplied as needed to a party that supplies products. Thus, while the user information including the user's private information and the product purchase request that involves privacy of the user are controlled by the party that manages the system, these pieces of information are processed or converted into other types of information to be supplied to the party that carries products and to the party that delivers the products so that these parties can perform their operations with high efficiency. It is thus possible to improve the efficiency with which the party that carries products or the party that delivers products perform their operations or activities, while preventing the user's private information from leaking outside.

The supply of the above-indicated information to the party carrying products or to the party delivering products may be in the form of regular or irregular transmission of the information to the relevant terminal, or reading (or observation) and retrieval of the information in response to an access from the terminal. Furthermore, the party that carries products and the party that delivers products may be the same party, and the terminals of these parties may be separate from each other or they can be the same terminal.

In the system or method as described above, where the product purchase request comprises a request for two or more products, the product selection information preferably includes a product list of at least one of the two or more products that can be packed in a single package. In many cases, the user buys two or more products rather than buying a single product. If a purchase request is made for two or more products, the system or method makes an attempt to pack these products into the same package in order to save the time and effort to deliver the respective products separately, thus assuring high efficiency in delivery. Where the purchase request includes a plurality of kinds of products, the plural kinds of products will be packed in a single package. Whether the products can be packed in a single package is determined not by the shop but by the management center (server), and the product list of the products that can be packed in a single package is supplied to the shop. This leads to a reduction in a load of the shop. Also, the shop is free from the time and effort to pack two or more products in separate packages each time a product purchase request is made, thus assuring an improved efficiency in processing the purchase request.

Preferably, the product list of the at least one of the two or more products that can be packed in a single package is produced on the basis of at least one of the weight and the volume of each of the products contained in the product purchase request. More specifically, the weights of the respective products are added up, and the products whose total weight does not exceed a predetermined allowable range are determined as being able to be packed in a single package. Instead or Additionally, the volumes of respective products are added up, and the products whose total volume does not exceed a predetermined allowable range are determined as being able to be packed in a single package. Naturally, it is preferable that the products are determined as being able to be packed in a single package when both the total weight and the total volume are within the allowable ranges. It is also possible for the user to specify the size of the package. Packing products in a single package is advantageous in an improved delivery efficiency and a reduction in the shipping cost. It is also possible to construct the system in such a way as to enable the user to select a pattern that minimizes the shipping cost in terms of the number and size of packages.

Preferably, the above-indicated product list of the at least one of the two or more products that can be packed in a single package is produced on the basis of a packaging characteristic of each of the products contained in the product purchase request. The packing characteristics mean characteristics inherent in a product which are desirably considered when the product is packed, and may be represented by warnings, for example, “Keep Refrigerated”, “Handling With Care”, and “Fragile”. Since it is not appropriate to pack products having opposite or dissimilar packing characteristics, for example, a product labeled “Keep Refrigerated” and a product labeled “NO REFRIGERATION”, in the same package, it is preferable to determine whether the products can be packed in the same package in view of the packing characteristics.

Preferably, when the product purchase request comprises a request for two or more products, the product selection information includes a pick-up order in which the products are picked up. In this case, the pick-up order may be determined on the basis of locations of the respective products in the shop. Thus, the shop, which is supplied with the pick-up order designated by the management center (server), can perform a packing operation with a further improved efficiency. The product pick-up order is determined on the basis of the locations of products in the shop so that the products can be picked up most efficiently. For example, if a purchase request is made for products “a”, “b”, “c” and “d”, wherein the products “a” and “d” are located close to each other and the products “b” and “c” are located close to each other in the shop, these products are preferably picked up and packed in the order of “a”-“d”-“b”-“c” with improved efficiency. For the location of each product, any suitable data format that can uniquely specify the location of the product in the shop may be employed, in addition to or instead of the shelf address of a shelf on which the product is placed. The form or format that represents the product pick-up order may be determined or selected as desired, and may differ from shop to shop. For instance, a product list of products to be transmitted to a certain shop contains product names and quantities that are written sequentially (from the top to the bottom) while a list to be transmitted to another shop contains the pick-up order that is described with Arabic numerals. Actual operations to pick up the products according to this list may be done manually by a staff member(s) of the shop or may be done automatically with a machine.

It is also preferable to transmit information pertaining to the at least one of the two or more products that can be packed in a single package, to the user terminal. While the management center (server) determines whether the products can be packed in a single package or not according to the invention, the result of the determination may be transmitted as a reply to the user, thus permitting the user to be informed in advance of the number of packages to be delivered to the user. This arrangement also enables the user to select only such products that can be packed in a single package. For example, if the user transmits a purchase request for products “a”, “b”, “c” and “d” and the management center determines that only the products “a”, “b” and “c” can be packed in the same package, the management center may send to the user through a web page or the like a message that only the products “a”, “b” and “c” can be packed in the same package and the product “d” will be in another package. It is also preferable to provide the user with combinations of products that can be packed in the same package, from among the products “a”, “b”, “c” and “d”. In one embodiment of the invention, the above-indicated shop is a general shop that carries a plurality of kinds of products.

Preferably, the product delivery information includes a delivery order in which the products are to be delivered. For example, when two or more users make purchase requests for products, the delivery order is specified so that the products can be delivered on an optimum route that is determined on the basis of the users' addresses included in the user information. Since the delivery order is determined by the management center (server), the load of the distributor is reduced and the delivery can be accomplished with improved efficiency. The delivery order is not limited to one for delivery to the users. Rather, the delivery order may be one in which products are collected from a plurality of shops that are supposed to ship the products. In this case, the management center defines or specifies an optimum route on the basis of addresses of the shops carrying the products.

It is also preferable to permit the user terminal to acquire at least one of a product selection status observed at the first party, and a delivery status observed at the second party. With the status information, the user is informed of the stage in which the product(s) purchased by the user currently is/are at any time, which leads to improved convenience or ease with which the system is used. The product selection status and the product delivery status may be occasionally transmitted from the party that carries products or the party that delivers products to the management center, which in turn transmit the status information to the user in response to a request from the user terminal.

### BRIEF DESCRIPTION OF THE DRAWINGS

The invention will be described in conjunction with the following drawings in which like reference numerals designate like elements and wherein:

FIG. 1 is a diagram schematically showing a system according to one embodiment of the invention;

FIG. 2 is a block diagram showing the construction of a management center in the system of FIG. 1;

FIG. 3 is view showing one example of a product information table contained in a product information database of FIG. 2;

FIG. 4 is a view for explaining the process for effecting electronic commercial transactions according to an aspect of the invention;

FIG. 5 is a flowchart of a process carried out by the management center of FIG. 1; and

FIG. 6 is a view showing one example of a product list created at the management center.

### DETAILED DESCRIPTION OF PREFERRED EMBODIMENT(S)

Hereinafter, a preferred embodiment according to the invention will be described referring to the drawings.

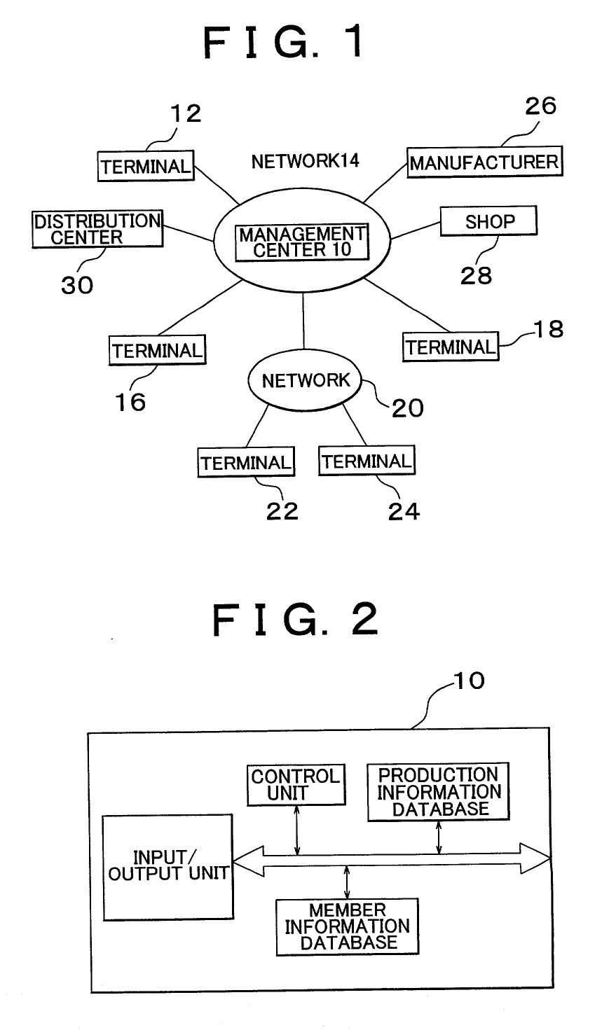

FIG. 1 schematically shows an electronic commerce system according to an embodiment of the invention. A management center 10 is provided for controlling and managing the electronic commerce system and has a server computer for storing product information. The management center 10 is connected to a user terminal 12 via a communication system, for example, the Internet, and the user can transmit a purchase request for a desired product or products to the management center 10 using the terminal 12. The terminal 12 may be, for example, a personal computer possessed by an individual. The terminal 12, as with all of the terminals, can connect to the communication system via communication lines or wirelessly (e.g., by an infrared or radio-wave interface).

Further, the management center 10 is connected to other user terminals 16, 18 and to another network 20, and to computer systems of a manufacturer 26, a shop 28 (e.g., a retail store) and a distribution center 30 that participate in the electronic commerce system, via a network 14. The network 14 may be the Internet, or may be another type of network (an intranet or an extranet) that uses a private line. The user terminal 16 and the user terminal 18 may be information terminals installed at convenience stores, or information terminals installed at people gathering facilities such as a railway station or other public facilities such as shopping malls, etc. Additionally, user terminals 22, 24 may be connected to the other network 20, and the network 20 may be the Internet or a network formed of private lines. The user terminal 22 and the user terminal 24 may be dedicated terminals installed at certain facilities such as an automobile dealer.

Thus, the user terminals 12, 16, 18, 22, 24 are respectively connected to the management center 10 via the network(s), and the user can transmit a purchase request for a desired product(s) to the management center 10 using any one of the terminals. Product data is supplied to the management center 10 from the manufacturer 26 or the shop 28 via the network 14 when appropriate. Where there is a change in the products that the manufacture 26 or the shop 28 carries, renewed or updated product data is supplied as needed to the management center 10. Therefore, the management center 10 always stores the latest product information. When the user wishes to buy a product, the user accesses the management center 10 using, for example, the terminal 12, and requests supply of the product information. Specifically, the user transmits a URL of a web page in which the product information supplied by the management center 10 is placed, and the management center 10 transmits to the terminal 12 the web page corresponding to the URL received from the terminal 12. The web page supplied by the management center 10 is displayed on the terminal 12 by use of a browser, and the user purchases a desired product while confirming product data placed on the web page. The purchase of the product can be accomplished, for example, by clicking a photograph or data of the desired product placed on the web page thereby to transmit the corresponding product data to the management center 10. In addition to or instead of specifying the desired product on the web page, the user can place an order by entering a product's name, product code, the number of products or items to be purchased, the time and date of delivery, delivery address (home address or other).

FIG. 2 is a block diagram showing the configuration of a computer system in the management center 10. This computer system includes an input/output unit (input/output interface), a control unit, a product information database, and a member information database. The member information database contains private information of members who use the electronic commerce system. More specifically, the member information contains a name, an address, an ID, a password and other information of each member. The product information database contains information relating to products supplied by the manufacturer 26 or the shop 28, and the product information stored in this database is placed on the web page and thus presented to the user.

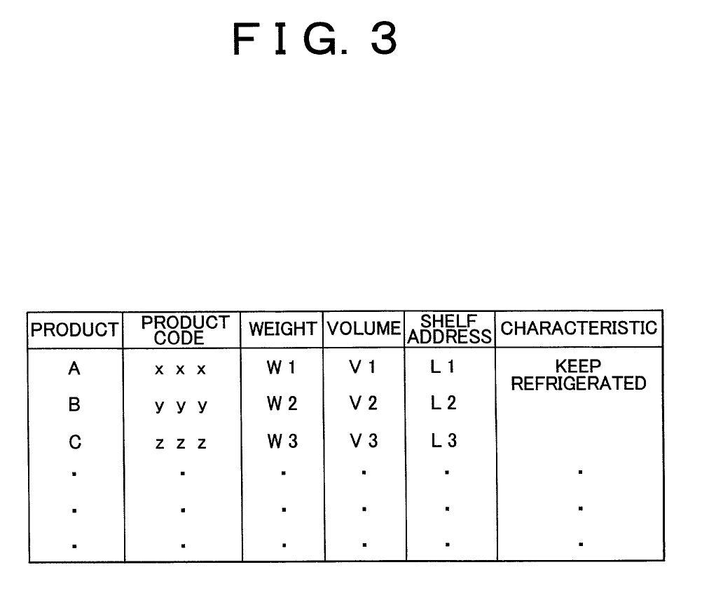

FIG. 3 shows one example of a product information table contained in the product information database of FIG. 2. The product information table includes a product code assigned to each of the products provided by the manufacturer 26 or the shop 28, and also includes data associated with the weight and volume of the product, the location of the product in the relevant shop (which will be called “shelf address” when appropriate), and a characteristic of the product, if any. Where the user wishes to buy two or more products, the data associated with the weight and volume of the product are used to determine whether the two or more products can be packed in a single package. When data of two or more products for which a purchase request was made by the user is transmitted to each shop, the shelf addresses in the product information table are used to determine or specify the order in which the products are to be picked up in the shop. Further, the characteristic of each product, as well as the weight and volume thereof, is used to determine whether two or more products, for which a purchase request was made by the user, can be packed in a single package. These items of information as well as product data may be supplied by the manufacturer 26 or the shop 28 to the product information database. The control unit of the management center 10 determines whether or not the products requested by the user can be packed in a single package, on the basis of a table such as that of FIG. 3 contained in the product information database. The control unit also creates a pick-up list that indicates the order in which the two or more products that can be packed in a single package are picked up in the shop for packing, using the product list and shelf addresses, and transmits the pick-up list to the shop that carries those products. In the case where the shop 28 carries or possesses a product or products requested by the user, data to be transmitted to the shop 28 consists solely of data necessary for specifying the product(s), and does not include the user's private information. That is, in this embodiment, the distribution center 30 that operates under control of the management center 10, rather than the shop 28, actually delivers the product(s) to the user, and hence it is unnecessary for the management center 10 to supply data for specifying the user to the shop 28.

Moreover, the control unit of the management center 10 creates data regarding the delivery address of the user on the basis of the user's name and address contained in the member information database, and transmits the data thus created to the distribution center 30. The data regarding the products, which is supplied to the shop 28, and the data regarding the delivery, which is transmitted to the distribution center 30, are each provided with some data that indicates a correlation between the two types of data. As such correlation data, for example, a job ID or the like may be used.

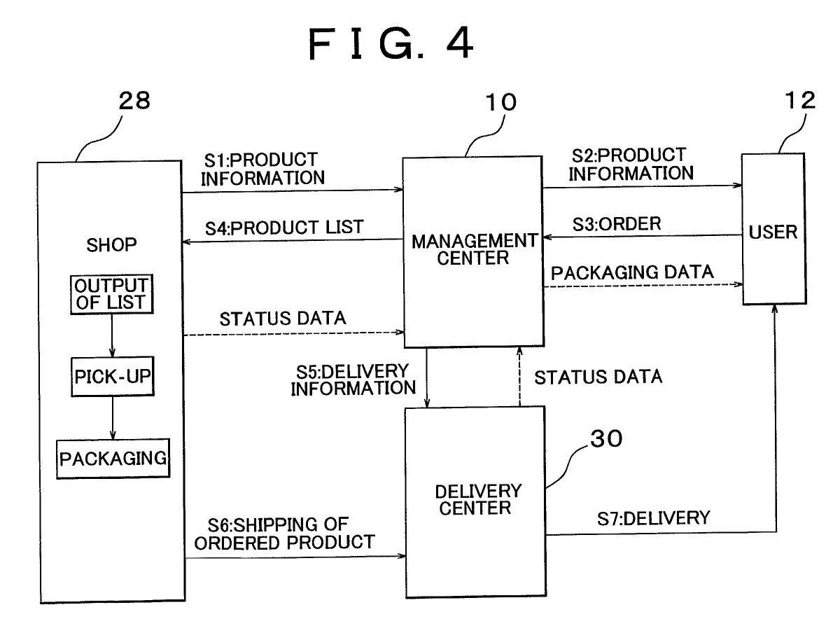

FIG. 4 shows the flow of the process or method for effecting electronic commerce according to this embodiment of the invention. Initially, the shop 28 transmits information on products possessed by the shop 28 to the management center 10 (step S1). The management center 10 stores the product information supplied by the shop 28 in the product information database. Next, the management center 10 supplies the product information contained in the product information database to the user terminal 12 in response to a request from the user terminal 12 (step S2). The user observes the product information displayed on the user terminal 12 and transmits a purchase request for a desired product or products to the management center 10 (step S3). The management center 10 receives this product purchase request (order) from the user terminal 12 and if the user wishes to buy two or more products, the management center 10 determines whether or not these products can be packed in a single package. This determination is made by using weight data and volume data of each product contained in the product information database. This determination also is made on the basis of the packing characteristic of the product contained in the product information database. The determination as to whether the two or more products can be packed in the same package will be described later in greater detail. After deciding whether or not the products can be packed in the same package, the management center 10 determines the order (pick-up order) in which the two or more products that can be packed in the same package are to be acquired or picked up, on the basis of the shelf addresses of the products contained in the product information database. The products that can be packed in the same package and the order of picking up the products are indicated in the form of a list, and transmitted as a product list to the shop 28 having these products (step S4).

At the shop 28 that receives and outputs the product list from the management center 10, the requested products are picked up from the shelves in the shop in the pick-up order indicated on this list (pick-up list) and are successively packed in a package. The pick-up order is determined on the basis of the shelf addresses so that the two or more products can be most efficiently picked up and packed in the shop 28. With the order thus determined, the two or more products can be picked up and packed within the shortest time. After packing of all the products requested by the user is completed, the products are shipped to the distribution center 30 (step S6). Instead of shipping the products from the shop to the distribution center 30, a distributor from the distribution center 30 may go to the shop 28 and pick up the products that were packed in the shop 28. The management center 10 performs operations to transmit the above-described product list to the shop 28 and at the same time transmits data indicative of the delivery address for the products to the distribution center 30 (step S5).

The distribution center 30 delivers a product package supplied by the shop 28 to the user according to delivery data supplied by the management center 10 (step S7). The delivery data includes the user's name and address as well as the job ID. Since the user's private information is only supplied in the form of delivery address data to the distribution center 30 controlled by the management center 10, and only data (the product list) for specifying the products is supplied to the shop 28, the user's private information does not leak to the shop 28 and other outside facilities.

Moreover, even when a user purchases two or more products, these products, if they can be packed in the same package, are delivered as a single package, thus assuring a high delivery efficiency.

When the delivery address data associated with the requested products is transmitted to the distribution center 30 in step S5, it is also preferable to send a list indicating the order of the delivery together with the address data. Specifically, when a plurality of users make purchase requests for products and the addresses of two or more of the users are close in location to each other, the order in which the products or packages can be delivered efficiently is determined and transmitted to the distribution center 30. In the case where the products are not shipped from the shop 28 to the distribution center 30 but are collected or picked up at the shop 28 by a distributor sent from the distribution center 30, it is also preferable that the management center 10 transmit data indicative of the order in which the products or packages are collected from two or more shops, in addition to the delivery address data for the requested products. The collection order may be decided on the basis of the addresses of the respective shops. Thus, the operations ranging from the collection to the delivery of the products can be performed with high efficiency, thus permitting the products to be delivered to the user(s) in a relatively short time.

Also, the management center 10 may carry out a certain settlement operation or process, and transmit product selection information to the shop 28 while also transmitting product delivery information to the distribution center 30. In the settlement operation, authentication can be accomplished by receiving a credit card number from the user terminal. The credit card number is controlled by the management center 10 and is not supplied to the shop 28, thus ensuring security. The settlement may be carried out by a method other than providing the credit card number. Where the user makes a purchase request for a product, for example, the management center 10 transmits payment data involved in the product purchase to the user terminal. The user prints out the payment data as needed and settles the payment at a convenience store or the like. The convenience store transmits the settlement information to the management center 10, which in turn determines that the payment was settled according to the settlement information from the convenience store. The management center 10 then transmits the product selection information and the product delivery information to the shop 28 and the distribution center 30, respectively.

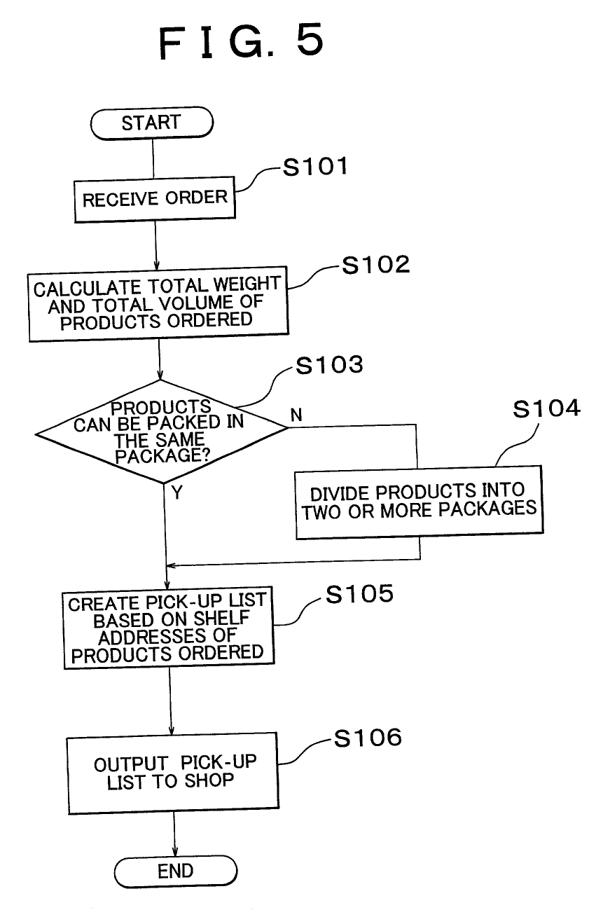

FIG. 5 shows a flowchart of the process of creating the product list at the management center 10. Initially, the management center 10 receives a purchase request (order) for a product or products from the user terminal 12 (step S101). Upon receipt of the product purchase request, the control unit of the management center 10 calculates the total weight and the total volume of the requested products by using the respective weights and volumes of the products that are contained in the product information database (step S102). After the total weight and the total volume are calculated, whether or not the products can be packed in the same package is determined (step S103). More specifically, it is determined whether or not the total weight calculated in step S102 is equal to or less than a predetermined allowable weight, and/or whether or not the total volume calculated in step S102 is equal to or less than a predetermined allowable volume. Naturally, it is preferable to determine whether or not the total weight and the total volume of the products are both equal to or less than the respective allowable values. When the total weight and the total volume of the products are both within the allowable values, the products requested by the user are judged as being able to be packed in the same package. On the contrary, when at least one of the total weight and the total volume exceeds its allowable value, the products are judged as being unable to be packed in the same package. In this case, the products for which a purchase request was made are divided into two or more packages (step S104).

When step S103 is executed to determine whether the products can be packed in the same package, it is also preferable to make this determination on the basis of packing characteristics inherent in the products in addition to the total weight and total volume of the products. For example, when two or more products that were determined as being able to be packed in the same package in terms of the weight and volume include one or more products that need to be kept cool or cold and one or more products that are not suited to being kept cool or cold, those products are separated into two or more packages because it is undesirable to pack them in the same package. Also, since it is also undesirable to pack a product that is relatively hard and a product that is fragile in the same package, the products are separated or divided into two or more packages.

After determining the possibility of packing the products in the same package in the above manner, the control unit of the management center 10 creates a pick-up list indicating the order of picking up the requested products, on the basis of the shelf addresses of the products to be contained in the same package. This pick-up order is determined as described above so that the products can be packed within the shortest time in the shop. For example, the list may represent an order in which the products can be sequentially picked up without requiring a person collecting the products to take the same path more than once.

After creating the pick-up list, the management center 10 transmits the thus created pick-up list to the shop 28 (step S106).

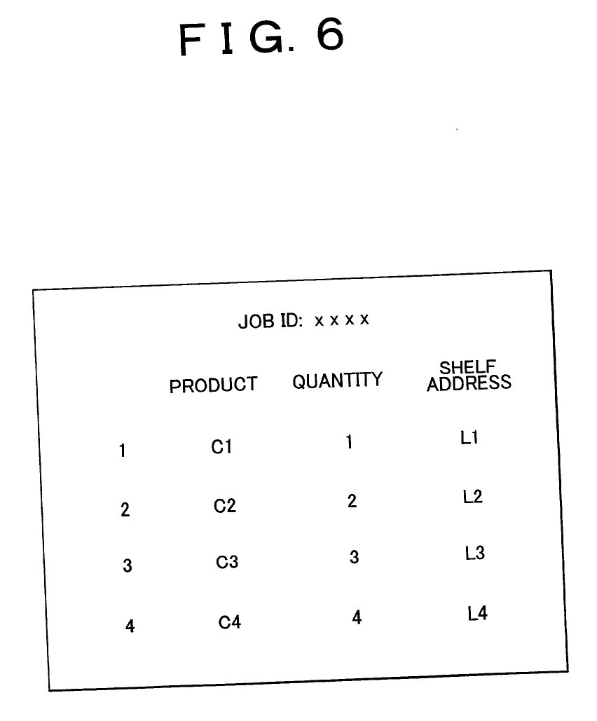

FIG. 6 shows one example of a pick-up list created in the above manner. One job ID is allocated to one package, and the products to be picked up, the quantities thereof, and the shelf addresses thereof are shown in the list in the order of pick-up. According to the list of FIG. 6, a piece of product C1 is initially picked up at a location having shelf address L1, a piece of product C2 is then picked up at a location having shelf address L2, and then three pieces of product C3 are picked up at a location having shelf address L3. Since the product list of the products requested by the user, which list is in such a form as in FIG. 6, is supplied from the management center 10 to the shop 28, it becomes possible for even a worker having little knowledge of the locations of the products to efficiently pack the requested products into a package and ship the package to the distribution center 30.

In this embodiment, it is also preferable that, as shown in FIG. 4, a packing status at the shop 28 can be sequentially supplied to the management center 10 and a delivery status of the products can be sequentially supplied from the distribution center 30 to the management center 10. Accordingly, when the user wishes to know the status of a product or products for which the user made a purchase request from the terminal 12 and makes a status inquiry, the management center 10 can immediately inform the user of the packing or delivery status of the products based on these status data.

While the management center 10 determines whether the products requested by the user can be packed in the same package in the illustrated embodiment, it is also preferable to inform the user of the result of the determination. Where the user makes a purchase request for two or more products, for example, the management center 10 may determine whether or not the two or more products requested by the user can be packed in a single package, and inform the user of the products that can be packed in the single package.

Moreover, in this embodiment, the shop 28 is to be interpreted to include various types of shops, such as department stores, supermarkets, and private stores.

In the foregoing, the preferred embodiment of the invention has been described. It is, however, to be noted that the embodiment covers the following technical concepts.

(1) A method for effecting electronic commerce using a computer network in which computers are interconnected, which method includes the steps of: (a) receiving a purchase request for a product or products from a user terminal, (b) where the user requests two or more products, creating a product list of the products that can be packed in a single package, and (c) transmitting the product list to a terminal of a shop that carries the products.

(2) A method for effecting electronic commerce as stated above at (1), wherein the product list of the products that can be packed in a single package is created on the basis of at least one of the weights or volumes of the respective products which are stored in advance in the product information database.

(3) A method for effecting electronic commerce as stated above at (1), wherein the product list of the products that can be packed in a single package includes data pertaining to the order of picking up the products, which order is determined on the basis of the locations of the products within the shop.

(4) A method for effecting electronic commerce as stated above at (1), wherein information regarding the products that can be packed in a single package is transmitted as a reply to the user terminal.

(5) An electronic commerce system that effects electronic commercial transactions using a computer network in which computers are interconnected, which system includes: (a) a terminal that transmits a purchase request for a product or products; (b) a computer (shop computer) located at a shop that carries the product(s); and (c) a management computer that receives the product purchase request, creates a product list when the user wishes to buy two or more products, which lists the product(s) that can be packed in the same delivery container, and transmits the product list to the shop computer.

(6) An electronic commerce system as stated above at (5), wherein the management computer creates the product list by comparing the total weight or the total volume of the products with an allowable weight or an allowable volume, respectively.

(7) An electronic commerce system as stated above at (5), wherein the management computer creates the product list in accordance with a pick-up order (an order of picking up the products) that is determined on the basis of the locations of the products in the shop.

(8) An electronic commerce system as stated above at (5), wherein the management computer transmits information regarding the products that can be stored in the same delivery container to the terminal.

(9) An electronic commerce management apparatus for managing electronic commercial transactions using a computer network in which computers are interconnected, which apparatus includes: (a) means for receiving a purchase request for a product or products from a user terminal connected to the computer network, (b) means for storing product information, and (c) means for creating a product list of the products that can be packed in the same package according to the product purchase request and the product information, and transmitting the product list to a shop.

(10) An electronic commerce management apparatus as stated above at (9), wherein the means for storing product information stores weight and volume data of the products.

(11) An electronic commerce management apparatus as stated above at (9), wherein the means for storing product information stores locations of the products in the shop.

(12) An electronic commerce management apparatus as stated above at (9), wherein the list of the products that can be packed in the same package is produced on the basis of at least one of the total weight and the total volume of the products.

(13) A method for effecting electronic commerce using a computer network in which computers are interconnected, which method includes the steps of: (a) receiving a purchase request for two or more products from a user terminal, (b) producing data that enable the products to be specified and transmitting the data to a terminal at a shop that carries the products, and (c) packing the products sent from the shop in the same package under a predetermined condition or conditions.

According to the invention as described above, a product purchase request sent from the user is adequately processed and the desired products can be efficiently delivered to the user. Moreover, the user's private information is prevented from leaking to the outside, thus assuring further improved system security and convenience.

In the illustrated embodiment, the control unit (controller) of the management center is implemented as a programmed general purpose computer. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. An electronic commerce system for effecting electronic commercial transactions using a computer network in which computers are interconnected, the system comprising:
means for identifying a user and generating user information in response to an access from a user terminal;
means for receiving a product purchase request from the user terminal;
means for creating product selection information for use by a first party that carries products, the product selection information for selection of at least one product, the product selection information is created on the basis of at least one of the product purchase request and the user information; and
means for creating product delivery information for use by a second party that delivers products, the product delivery information for delivery of the at least one product, the product delivery information is created on the basis of at least one of the product purchase request and the user information.

2. An electronic commerce system according to claim 1, wherein when the product purchase request comprises a request for two or more products, the means for creating product selection information causes the product selection information to include a product list of at least one of the two or more products that can be packed in a single package.

3. An electronic commerce system according to claim 2, wherein the product list of the at least one of the two or more products that can be packed in a single package is produced by the means for creating product selection information on the basis of at least one of a weight and a volume of each of the products contained in the product purchase request.

4. An electronic commerce system according to claim 2, wherein the product list of the at least one of the two or more products that can be packed in a single package is produced by the means for creating product selection information on the basis of a packaging characteristic of each of the products contained in the product purchase request.

5. An electronic commerce system according to claim 1, wherein when the product purchase request comprises a request for two or more products, the means for creating the product selection information causes the product selection information to include a pick-up order in which the products are picked up, the pick-up order being determined on the basis of locations of the respective products in the first party.

6. An electronic commerce system according to claim 2, further comprising:
means for transmitting information pertaining to the at least one of the two or more products that can be packed in a single package, to the user terminal.

7. An electronic commerce system according to claim 1, wherein the first party that carries products is a general shop that carries a plurality of types of products.

8. An electronic commerce system according to claim 1, wherein the means for creating product delivery information causes the product delivery information to include a delivery order in which the products are to be delivered.

9. An electronic commerce system according to claim 1, further comprising:
means for permitting the user terminal to acquire at least one of a product selection status observed at the first party, and a delivery status observed at the second party.

10. An electronic commerce system according to claim 1, further comprising:
means for providing the user terminal with product information in response to a search request from the user terminal.

11. An electronic commerce system according to claim 1, wherein one of the product selection information and the product delivery information includes encrypted, secure information about the user, and the other of the product selection information and the product delivery information does not include the encrypted, secure information about the user.

12. An electronic commerce method for effecting electronic commercial transactions using a computer network in which computers are interconnected, the method comprising the steps of:
identifying a user in response to an access from a user terminal, to generate user identification information;
receiving a product purchase request from the user terminal;
creating product selection information needed for selection of at least one product and creating product delivery information needed for delivery of the at least one product, on the basis of at least one of the user identification information and the product purchase request;
sending the product selection information to a terminal of a first party that carries products; and
sending the product delivery information to a terminal of a second party that delivers products.

13. An electronic commerce method according to claim 12, wherein when the product purchase request comprises a request for two or more products, the product selection information includes a product list of at least one of the two or more products that can be packed in a single package.

14. An electronic commerce method according to claim 13, wherein the product list of the at least one of the two or more products that can be packed in a single package is produced on the basis of at least one of a weight and a volume of each of the products contained in the product purchase request.

15. An electronic commerce method according to claim 13, wherein the product list of the at least one of the two or more products that can be packed in a single package is produced on the basis of a pack aging characteristic of each of the products contained in the product purchase request.

16. An electronic commerce method according to claim 12, wherein when the product purchase request comprises a request for two or more products, the product selection information includes a pick-up order in which the products are picked up, the pick-up order being determined on the basis of locations of the respective products in the first party.

17. An electronic commerce method according to claim 13, further comprising the step of:
transmitting information pertaining to the at least one of the two or more products that can be packed in a single package, to the user terminal.

18. An electronic commerce method according to claim 12, wherein the first party that carries products is a general shop that carries a plurality of types of products.

19. An electronic commerce method according to claim 12, wherein the product delivery information includes a delivery order in which the products are to be delivered.

20. An electronic commerce method according to claim 12, further comprising the step of:
permitting the user terminal to acquire at least one of a product selection status observed at the first party, and a delivery status observed at the second party.

21. An electronic commerce method according to claim 12, further comprising the step of:
providing the user terminal with product information in response to a search request from the user terminal.

22. An electronic commerce method according to claim 12, wherein one of the product selection information and the product delivery information includes encrypted, secure information about the user, and the other of the product selection information and the product delivery information does not include the encrypted, secure information about the user.

23. An electronic commerce method for effecting electronic commerce using a computer network in which computers are interconnected, the method comprising the steps of:
receiving a purchase request for at least one product from a user terminal;
determining whether the purchase request is for more than one product;
when the user request is determined to be for more than one product, creating a product list of the products that can be packed in a single package; and
transmitting the product list to a terminal of a party that carries the products.

24. An electronic commerce method according to claim 23, wherein the product list of the products that can be packed in a single package is created on the basis of at least one of a weight and a volume of the respective products which are stored in advance in a product information database.

25. An electronic commerce method according to claim 23, wherein the product list of the products that can be packed in a single package includes data pertaining to the order of picking up the products, which order is determined on the basis of locations of the products within premises of the first party.

26. An electronic commerce method according to claim 23, wherein information regarding the products that can be packed in a single package is transmitted as a reply to the user terminal.

27. An electronic commerce system that effects electronic commercial transactions using a computer network in which computers are interconnected, the system comprising:
means for receiving a purchase request for at least one product from a user at a user terminal;
means for creating a product list when the received purchase request is for more than one product and at least two of the requested products can be packed in a single package, the product list listing the at least two products that can be packed in the single package; and
means for transmitting the product list to a party that carries the products.

28. An electronic commerce system according to claim 27, wherein the means for creating a product list creates the product list by comparing at least one of a total weight and a total volume of the products with an allowable weight or an allowable volume, respectively.

29. An electronic commerce system according to claim 27, wherein the means for creating a product list creates the product list in accordance with a pick-up order that is determined on the basis of the locations of the products in the premises of the party that carries the products.

30. An electronic commerce system according to claim 27, further comprising means for transmitting information regarding the products that can be stored in the single package to the user terminal.

31. An electronic commerce management apparatus for managing electronic commercial transactions using a computer network in which computers are interconnected, the apparatus comprising:
means for receiving a purchase request for at least one product from a user terminal connected to the computer network;
means for storing product information;
means for determining whether the purchase request is for more than one product;
means for creating, when the purchase request is determined to be for more than one product, a product list of requested products that can be packed in a single package according to the product purchase request and the product information; and
means for transmitting the product list to a party that carries the products.

32. An electronic commerce management apparatus according to claim 31, wherein the means for storing product information stores weight and volume data of the products.

33. An electronic commerce management apparatus according to claim 31, wherein the means for storing product information stores locations of the products at premises of the party that carries the products.

34. An electronic commerce management apparatus according to claim 31, wherein the list of the products that can be packed in the single package is produced on the basis of at least one of a total weight and a total volume of the products.

35. An electronic commerce method for effecting electronic commerce using a computer network in which computers are interconnected, the method comprising the steps of:
receiving a purchase request for two or more products from a user terminal;
determining whether at least two of the requested products can be packed in a single package based upon predetermined criteria; and
producing data that enables the products to be specified and packed in the single package if it is determined that at least two of the products can be packed in the single package, and transmitting the data to a terminal at a party that carries the products.
